(19) United States
(12) Patent Application Publication
(10) Pub. No.: US 2024/0013120 A1
(43) Pub. Date: Jan. 11, 2024

(54) DEVELOPMENT OF POTENTIAL READINESS ADVISORY TOOL (PRAT)

(71) Applicant: SAUDI ARABIAN OIL COMPANY, Dhahran (SA)

(72) Inventor: Mohammed A. Al-Abdulhay, Ahsa (SA)

(73) Assignee: SAUDI ARABIAN OIL COMPANY, Dhahran (SA)

(21) Appl. No.: 17/811,532

(22) Filed: Jul. 8, 2022

(51) Int. Cl. G06Q 10/06; G06Q 50/02

(52) U.S. Cl. CPC G06Q 10/0637; G06Q 50/02

(57) ABSTRACT

Systems and methods for determining if a crude production rate from a plurality of wells will meet a required crude production rate of a strategic business plan are disclosed. The method includes obtaining a required crude production rate for a primary-process plant facility (PPPF) from a strategic business plan; obtaining, from a PPPF database, a maximum processing capacity, a maximum discharge pump capacity, and a maximum re-injection well capacity for a plurality of raw crude components; and obtaining, from an exploration and production database, a maximum rate for production of raw crude and re-injection of salt water and gas for each of a plurality of wells operatively connected to the primary-process plant facility. The method further includes determining a maximum crude production rate based on the obtained information, and further determining if the maximum crude production rate equals or exceeds the required crude production rate.

### BACKGROUND

A typical primary-process plant facility (PPPF) is connected to a plurality of production wells and re-injection wells. The plant has a pre-existing design capacity for maximal production and discharge pump limit for raw crude components (i.e., crude, gas, and salt water), as well as a maximal re-injection rate for the salt water and gas. This design includes the number of discharge pumps and capacity for each pump. For each production well, readings are recorded of the maximum production rate of each component of production, i.e., crude, salt water, and gas. For each re-injection well, readings are recorded of the maximum injection rate for each waste fluid, i.e., salt water and gas. Both the maximum production rate and the maximum injection rate may include full rate (FR) and restricted rate (RR), where the RR includes any additional restrictions imposed by the current condition, e.g., maintenance operations, of the system. All these are tested in the field, validated, and then stored in an E&P database.

A controlling organization specifies a Strategic Business Plan Maximum Capacity (SBPMC) for each PPPF, the maximal production potential required from a PPPF in case of high demand.

Decisions regarding production of a PPPF according to the SBPMC are often made manually and in an ad hoc fashion. An automated method that uses the E&P database to determine the capability of a PPPF to accomplish its strategic goals, or to propose remedy actions in case of operational problems, is desirable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments related to methods for determining if a crude production rate from a plurality of wells will meet a crude production rate of a strategic business plan are disclosed. The method includes obtaining a required crude production rate for a PPPF from a strategic business plan; obtaining, from a PPPF database, a maximum processing capacity, a maximum discharge pump capacity, and a maximum re-injection well capacity for a plurality of raw crude components; and obtaining, from an exploration and production database, a maximum rate for production of raw crude and re-injection of salt water and gas for each of a plurality of wells operatively connected to the PPPF. The method also includes determining a maximum crude production rate based on the maximum processing capacity, the maximum discharge pump capacity, the maximum re-injection well capacity, and the maximum rate of production of raw crude and re-injection of salt water and gas. The method further includes determining if the maximum crude production rate equals or exceeds the required crude production rate.

In general, in one aspect, embodiments related to a non-transitory computer readable medium storing instructions executable by a computer processor with functionality for determining if a crude production rate from a plurality of wells will meet a crude production rate of a strategic business plan are disclosed. The instructions includes receiving a required crude production rate for a PPPF from a strategic business plan; receiving, from a PPPF database, a maximum processing capacity, a maximum discharge pump capacity, and a maximum re-injection well capacity for a plurality of raw crude components; and obtaining, from an exploration and production database, a maximum rate for production of raw crude and re-injection of salt water and gas for each of a plurality of wells operatively connected to the PPPF. The instructions also include determining a maximum crude production rate based on the maximum processing capacity, the maximum discharge pump capacity, the maximum re-injection well capacity, and the maximum production rate of raw crude and re-injection of salt water and gas. The instructions further include determining if the maximum crude production rate equals or exceeds the required crude production rate.

In general, in one aspect, embodiments related to a system configured for determining if a crude production rate from a plurality of wells will meet a crude production rate of a strategic business plan are disclosed. The system includes a strategic business plan containing a required production rate, at least one production well, at least one disposal well, a processing facility connected to at least one production well and at least one disposal well, a database, and a computer processor. The system is configured to obtain a required crude production rate for a PPPF from a strategic business plan; obtain, from a PPPF database, a maximum processing capacity, a maximum discharge pump capacity, and a maximum re-injection well capacity for a plurality of raw crude components; and obtain, from an exploration and production database, a maximum rate for production of raw crude and re-injection of salt water and gas for each of a plurality of wells operatively connected to the primary-process plant facility. The system is also configured to determine a maximum crude production rate based on the maximum processing capacity, the maximum discharge pump capacity, the maximum re-injection well capacity, and the maximum rate of production of raw crude and re-injection of salt water and gas. The system is further configured to determine if the maximum crude production rate equals or exceeds the required crude production rate.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a primary-process plant facility connected to a plurality of production wells, a plurality of re-injection wells, and a database, according to one or more embodiments.

FIG. 2 depicts an expert system according to one or more embodiments.

FIG. 3 shows pseudocode for an expert system according to one or more embodiments.

FIG. 4 shows a decision tree representation of an expert system according to one or more embodiments.

FIG. 5 shows a flowchart according to one or more embodiments.

FIG. 6 shows a computing device according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

One of more embodiments relate to a Potential Readiness Advisory Tool (PRAT). The PRAT is an automated computer implemented system configured to retrieve production, process, and disposal data from one or more databases, and determine if the production wells, the primary-process plant facility, and the waste re-injection wells operating together can meet the required production rate and to recommend remediating actions if it cannot. The PRAT facilitates systematic, reliable, and repeatable handling of data from large numbers of system components, e.g., hundreds of production wells.

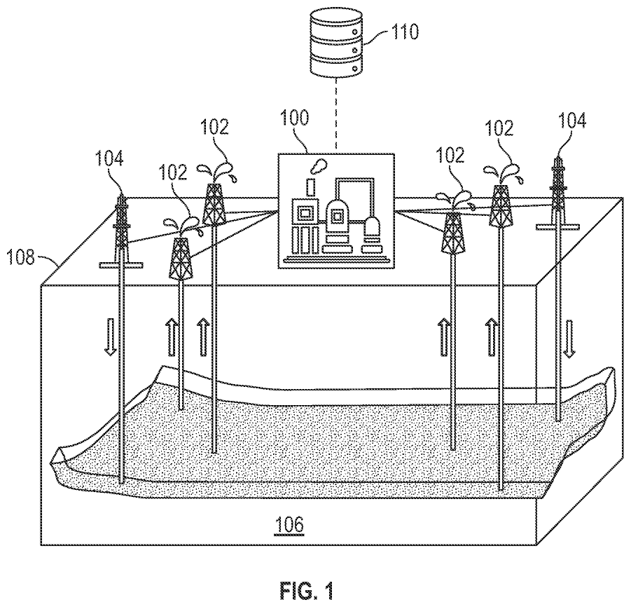

FIG. 1 depicts a PPPF (100), a plurality of production wells (102), and a plurality of re-injection wells (104) according to one or more embodiments. Although, for clarity, only a small number of production and re-injection wells (104) are displayed, typically many production and re-injection wells (104) may be connected to a PPPF (100). Production wells (102) draw raw crude components (crude, salt water, and gas), from a subsurface reservoir (106) in an oil field (108). Each production well (102) is connected, usually by a pipeline, to the PPPF (100). The raw crude components may be transported via the connection to the PPPF (100), where the crude is separated from salt water and gas. Gas drawn up from the subsurface as a raw crude component may also be referred to as “associated gas,” since it is the gas that is associated with crude production. Herein, we refer to gas and associated gas simply as “gas.”

Facility data from the PPPF (100) database may include information regarding the capability of the PPPF (100) to process the raw crude components, the capability of the discharge pumps to dispose of waste products, and the capability of the re-injection wells (104) to receive gas and saltwater waste from the PPPF (100) and re-inject them back into sub-surface reservoir (106), if needed, according to the process layout of the field development master plan.

As depicted in FIG. 1, the PPPF (100) is connected to a plurality of production wells (102) and re-injection wells (104). The re-injection wells (104) re-inject salt water and gas into the subsurface reservoir (106). Re-injection may serve two purposes, firstly disposal of the waste salt water and gas and secondly, to provide pressure support within the subsurface reservoir (106) or artificial lift in certain field developments where a gas lift system is needed. The production and re-injection wells (104) have two rate-test measurements. FR signifies the maximum possible production rate. RR signifies normal operation. The rate-test data consists of other data not limited to the test type (full-rate or restricted-rate), including produced crude, produced gas, and produced salt water. These re-injection wells (104) are frequently tested in the field and validated. The rate-test measurements are stored in an Exploration and Production (E&P) database (110) with full details. The E&P database (110) may be located within the process plant (100) or may be located in a remote location and operatively connected to the plant (100). An example of rate test data from the E&P database (110) is shown in Table 1, below. CCRR is “cumulative crude restricted rate,” CSWD is “cumulative salt water disposal,” and CAG is “cumulative associated gas.”

TABLE 1
Rate test and cumulative production data.

| Facility ABCD | | Single Reading | | | Cumulative Reading | | | |
|---|---|---|---|---|---|---|---|---|
| Production Order | | FR | RR | Water | [symbol] | [symbol] | [symbol] | CAG |
| 1 | Well [symbol] A | [symbol] | [symbol] | 823 | [symbol] | 1829 | [symbol] | [symbol] |
| 2 | Well [symbol] B | 6722 | [symbol] | [symbol] | [symbol] | [symbol] | [symbol] | 468 |
| 3 | Well [symbol] C | 4998 | [symbol] | [symbol] | 293 | [symbol] | [symbol] | [symbol] |
| 4 | Well [symbol] D | [symbol] | [symbol] | [symbol] | [symbol] | [symbol] | [symbol] | 778 |
| 5 | Well [symbol] E | [symbol] | 330 | [symbol] | [symbol] | [symbol] | [symbol] | [symbol] |
| 6 | Well [symbol] F | [symbol] | [symbol] | [symbol] | [symbol] | [symbol] | [symbol] | [symbol] |
| 7 | Well [symbol] G | [symbol] | [symbol] | [symbol] | [symbol] | 15730 | 7528 | [symbol] |
| 8 | Well [symbol] H | [symbol] | [symbol] | [symbol] | [symbol] | [symbol] | [symbol] | [symbol] |
| 9 | Well [symbol] I | [symbol] | 928 | 415 | [symbol] | [symbol] | [symbol] | [symbol] |
| 10 | Well [symbol] J | [symbol] | 22 [symbol] | [symbol] | [symbol] | [symbol] | [symbol] | [symbol] |

[symbol]

indicates data missing or illegible when filed

In one or more embodiments disclosed herein, the data gathered and stored in the E&P database (110) is used to build the PRAT (advisory tool). Embodiments disclosed herein link the E&P data to related information in the SBPMC regarding the associated produced gas and the associate produced water (salt water disposal). In the E&P database (110), each well has coded information such as which facility it is connected to, the date it was drilled, the type of the well completion, the last rate-test data, and the type of test (FR or RR). For each facility, all rate-test data for the connected wells (crude, gas, and water) is aggregated to produce an overall production performance of that facility. The PRAT compares the E&P data (actual produced gas, actual produced water) and the strategic goals for produced water and produced gas specified by the SBPMC.

The production data stored in the E&P database (110) may be combined with the facility design information obtainable from the facility owner, including the number of discharge pumps, processing limits, and the discharge pump limits. This integration of the SBPMC requirements, the facility data, and the data in the E&P database (110) allows the PRAT to evaluate the readiness of any PPPF (100).

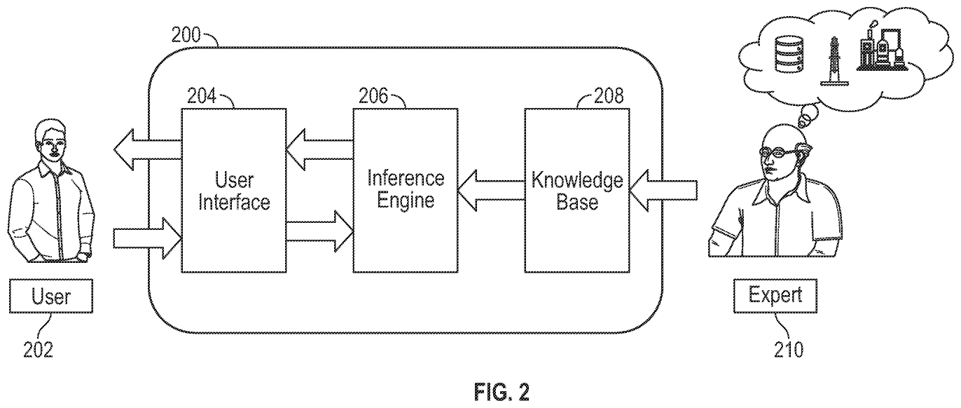

FIG. 2 depicts an “expert system” (200) according to one or more embodiments. The expert system (200) is a form of artificial intelligence (AI) that relies on a group of logical rules to take information and infer a deduction. The expert system (200) is constructed by an expert (210) who has a large knowledge base (208) in a particular subject matter—in this case, the operation of a PPPF (e.g., 100). This expert (210) would likely be a facility engineer or manager with many years of experience operating a PPPF (100). The knowledge base (208) may include best practices and remedies for problems commonly encountered by a PPPF (100). The expert (210) writes a computer program that codifies his knowledge base (208) and takes input from a user (202) through a user interface (UI) (204) and applies a sequence of logical decision rules to arrive at a recommended action. For development of the PRAT, the user (202) would be, for example, a manager at the strategic level who needs to verify the capability of the PPPF (100) to meet the requirements of the SBPMC. In one or more embodiments, the user interface (204) may be, without limitation, a graphical user interface (GUI), a text-based command line program, or any other suitable UI. The type of information entered by the user into the UI may include data from the E&P database (110), the SBPMC, and the facility data from the PPPF (100).

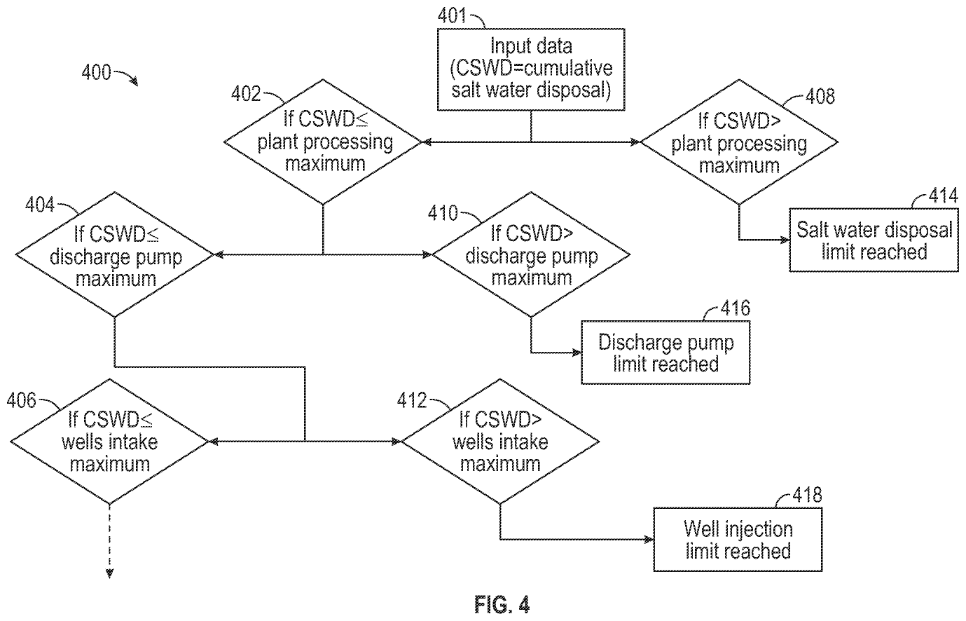

The part of the expert system (200) that contains the expert's (210) knowledge in the form of the logical decision rules (such as if/then statements) is known as an “inference engine” (206). In classical artificial intelligence applications, the inference engine (206) within an expert system (200) generally works by either forward-chaining or backward-chaining. The “chain” referred to in the names of these methods are equivalent to the nodes and edges of the graphical representation of a decision tree, presented below in FIG. 4. Backward-chaining methods are supplied with a conclusion (the “then” part of the logical rule), and then try to determine the most likely premise that would satisfy all the if/then statements contained in the inference engine (206) of the expert system (200). Backward-chaining is potentially very computationally complex since it requires searching over all possible premises for one that optimally satisfies the conclusions. As the set of possible premises increases, a backward-chaining expert system (200) becomes prohibitively expensive to implement. Opposite to backward-chaining, the forward-chaining method proceeds from the “if” part of the statement (i.e., the premises) and arrives at the logical conclusion. It does not require a search over a set of possible premises and is therefore much less computationally intensive. The forward-chaining method is used by the inference engine (206) in the expert system (200) of the PRAT.

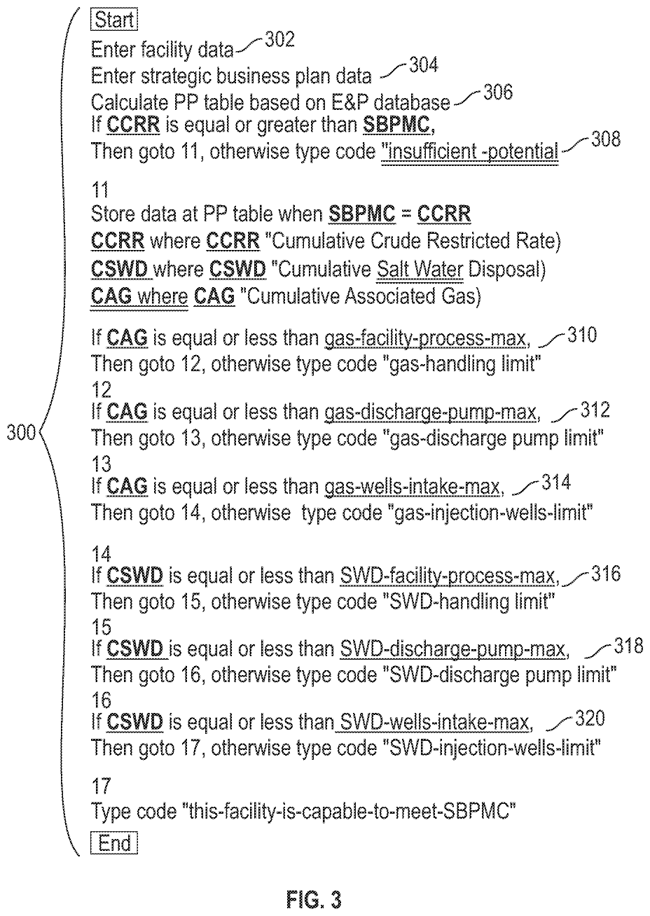

FIG. 3 shows an example of pseudocode (300) for the inference engine (206) of an expert system (200). Specifically, FIG. 3 shows an example of the type of code/algorithm that the expert (210) may write based on the expert's (210) knowledge. The pseudocode (300) example first requests the user to enter data related to the PPPF (100, 302) and the SBPMC (304). The pseudocode (300) then calculates a production priority table (Table 1, above; 306), based on the E&P database (110). This produces the Strategic Production Sequence (SPS)—the sort order of the wells connected to the PPPF (100) that will be produced. For example, in some embodiments, the SPS may specify the order in which wells are brought into production to meet the required cumulative production. In other embodiments, the SPS may specify the order in which the wells have their production raised from their RR to the FR. The pseudocode (300) takes the data and proceeds through a sequence of logical decision rules to determine whether the goals of the SBPMC are being met and, if not, what course or remedial action should be taken.

TABLE 2
Examples of applying PRAT to different primary-process plant facilities.

| | Process Capacity | | | Discharge Pump capacity | | | Well re-injection capacity | | | # discharge pump | | |
|---|---|---|---|---|---|---|---|---|---|---|---|---|
| Facility | Crude | SWD | AG | Crude | SWD | AG | Crude | SWD | AG | Crude | SWD | AG |
| ABCD | 90 | 150 | 50 | 90 | 130 | 50 | — | 130 | 50 | 3 | 2 | 3 |
| EFGH | 120 | 180 | 60 | 120 | 180 | 55 | — | 180 | 55 | 4 | 4 | 1 |
| [symbol] KL | 100 | 170 | 55 | 100 | 170 | 55 | — | 170 | [symbol] 5 | 3 | 3 | 3 |
| MNOP | 80 | 120 | 30 | 80 | 100 | 25 | — | 100 | 25 | 3 | 5 | 3 |
| XYWZ | 77 | 110 | 25 | 77 | 110 | 20 | — | 110 | 20 | 1 | 1 | 1 |

| | BP | PP | | | CODE | Propose Action |
|---|---|---|---|---|---|---|
| Facility | MSC | CCRR | CSWD | CAG | Y/N | NA |
| ABCD | 80 | 80 | 100 | 45 | Y | NA |
| EFGH | 110 | 100 | 110 | 50 | N | Stimulation |
| [symbol] KL | 100 | 100 | 90 | 50 | Y | NA |
| MNOP | 80 | 80 | 70 | 20 | Y | NA |
| XYWZ | 70 | 70 | 130 | 15 | N | Upstage pump |

[symbol]

indicates data missing or illegible when filed

Table 2 above presents an embodiment of the output from the PRAT for several different primary-process plant facilities (100), listed in the “Facility” column. This table will be used to illustrate the steps taken in the pseudocode of FIG. 3. Following the first logical decision rule shown in the pseudocode, the cumulative crude restricted rate (CCRR) is first compared to the quantity required by the SBPMC (308), here listed in the column with headers “BP—MSC”. If the CCRR is greater than or equal to the strategic goal required by the SBPMC, the next logical rule is evaluated, which is to compare the cumulative associated gas (CAG) with the capacity of the PPPF (100, 310), here listed in the “Process Capacity—AG” column. If the CAG is less than or equal to the capacity of the PPPF (100), the logical decision rule is passed and the inference engine (206) proceeds to the next rule, which is to compare the CAG with the maximum capacity of the discharge pump (312), here listed in the column “Discharge pump capability—AG”. If the CAG is less than or equal to the discharge pump maximum capacity, the inference engine (206) proceeds to the next logical decision rule, which is to compare the CAG to the maximum re-injection capacity (314), here listed in the column “Wells re-injection capability—AG”. If the CAG is less than the maximum re-injection capacity, the inference engine (206) proceeds to the following logical decision rule, which is to compare the cumulative salt water disposal (CSWD) to the capacity of the PPPF (100, 316), here listed in column “Process Capacity—SWD.” If less than or equal to this number, the next logical decision rule is evaluated, which is to compare the CSWD with the maximum capacity of the discharge pump (318), here listed in the column “Discharge pump capability—SWD.” If the CSWD is less than or equal to the discharge pump maximum capacity, the inference engine (206) proceeds to the next logical decision rule, which is to compare the CSWD to the maximum re-injection capacity (320), here listed in the column “Wells re-injection capability—SWD.”If the logical decision rule is passed, the inference engine (206) proceeds to any other logical rules incorporated into the expert system (200). In Table 2, the rows, corresponding to facilities ABCD, IJKL, and MNOP proceeded without any failures to pass the logical decision rules, and thus have no proposed action in the final column.

On the other hand, if any of the logical decision rules fail, the expert system (200) returns an error message along with a proposed remedy. Examining Table 2, the expert system (200) flagged problems for Facilities EFGH and XYWZ, and have proposed actions listed in the final column. For PPPF (100) EFGH, the CCRR is less than the amount required by the SBPMC, hence the recommended action of “stimulation.” For primary process plant facility (100) XYWZ, the CSWD is greater than its maximum capacity, hence a recommended action of “upstage pump” appears in the final column.

In one or more embodiments, Table 3 below presents an example list of problem codes used in the PRAT and their associated remedy actions. For example, in the third row, when the gas discharge pump limit has been exceeded, the proposed remedy actions include “Upstage/upgrade” and/or “Install new pump.” In the first row, if the well has insufficient potential, then actions that may be taken include drilling more wells, stimulating existing wells, or relaxing the choke on existing wells, etc.

Those skilled in the art will appreciate that the above codes and corresponding remedy actions are for purposes of example only, and that many other codes and remedy actions may be envisioned without departing from the scope disclosed herein.

TABLE 3
Problem code and proposed remedy action.

| Column-A: Code | Column-B: Proposed remedy action |
|---|---|
| insufficient-potential | Drill more wells |
| | Sidetrack wells |
| | Relax choke |
| gas-handling limit | upgrade the process facility |
| | Install new process facility |
| | Review SPS |
| gas-discharge pump limit | Upstage/upgrade |
| | Install new pump |
| gas-injection-wells-limit | Drill more wells |
| | Sidetrack wells |
| | Relax choke |
| | stimulate the existing wells |
| SWD-handling limit | upgrade the process facility |
| | Install new process facility |
| | Review SPS |
| SWD-discharge pump limit | Upstage/upgrade |
| | Install new pump |
| SWD-injection-wells-limit | Drill more wells |
| | Sidetrack wells |
| | Relax choke |
| | stimulate the existing wells |

FIG. 4 shows a decision tree (400) in accordance with one or more embodiments. The decision tree (400) is a visual representation of the inference engine (206) of the expert system (200). Beginning with the information input from the user and parameter assignments (401), the decision tree presents the various decisions to be made by the expert system (200) as intermediate nodes (402, 404, 406, 408, 410, 412) on a tree graph. Deductions inferred by the expert system (200) are represented by terminal nodes of the tree graph (414, 416, 418). The decision tree (400) arrives at the deductions (414, 416, 418) by taking the input data (401) from the user (202) and following the branches of the tree based on the logical decision rules created by the expert (210).

For the PPPF (100), FIG. 4 shows an example of a decision tree for part of the computer program in FIG. 3 pertaining to one particular parameter input by the user: CSWD, the quantity of salt water that has been separated from the crude and will be re-injected into the subsurface. The CSWD passes through a first logical decision rule (402, 408) which checks whether it has exceeded the PPPF (100) maximum. If so (408), the expert system (200) triggers a warning to the user (414). If the CSWD passes the first logical decision rule (402), another logical decision rule is evaluated (404, 410): Whether the value of the variable exceeds the discharge pump maximum. If it does (step 410), another warning is given to the user (416). If this logical decision rule is passed (404), the next rule checks whether the value of the CSWD is greater than the re-injection wells' (104) intake maximum (406, 412). If so (412), another warning is triggered (418). If not (406), the expert system continues to the next logical decision rule. In a more realistic situation, there may be many input parameters, many logical decision rules, and multiple branches for each logical decision rule.

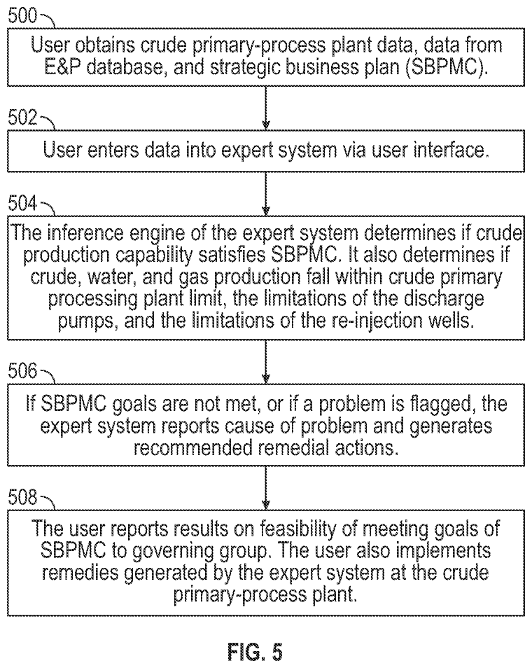

FIG. 5 presents the workflow of the PRAT. In step (500), the user (202) obtains the necessary information for the PRAT, including PPPF (100) data, data from the E&P database (110), and requirements from the SBPMC. In step (502), the user (202) enters the collected data into the PRAT through the user interface (204). In step (504), the PRAT determines if the crude production capability satisfies the requirements of the SBPMC. The PRAT also determines, on a facility-by-facility basis, the Strategic Business Plan Maximum Capacity (SBPMC) status in a very specific manner, to ensure the readiness of the SBPMC. Further, the PRAT determines if crude, water, and gas production fall within PPPF (100) limits, the limitations of the discharge pumps, and the limitations of the re-injection wells (104). In step (506), if the SBPMC goals are not met, or another problem is flagged (such as exceeding the limits of discharge pumps or re-injection wells), the PRAT determines cause of problem, reports the problem to the user (202), and recommends remedial actions. In step (508), the user reports the results of the PRAT back to the governing group who initially created the SBPMC. This information includes whether crude production will meet the goals of the SBPMC, and if not, what remedies exist to resolve the problems. Finally, the user (202) implements the solutions recommended by the expert system (200).

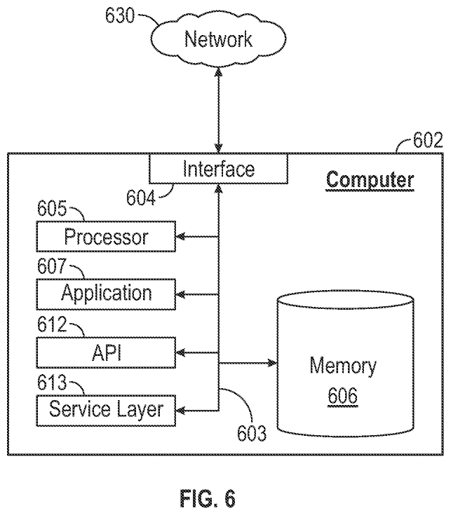

FIG. 6 further depicts a block diagram of a computer system (602) used to provide computational functionalities associated with described algorithms, methods, functions, processes, flows, and procedures as described in this disclosure, according to one or more embodiments. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or another suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), wherein each computer (602) communicates over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

Embodiments disclosed herein relate to utilizing the production data and after-production environment (above-ground), such as production related parameters, and real challenges related to surface facilities, i.e., after putting the hydrocarbon wells/facilities on stream and service. Most importantly, embodiment disclosed herein help to generate a quick and firm status about the readiness of any processing-facility, especially if there are several facilities being operated in a wide-range of geographical area where each facility has it is challenges and limits

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a required crude production rate for a primary-process plant facility (PPPF) from a strategic business plan;
obtaining, from a PPPF database, a maximum processing capacity, a maximum discharge pump capacity, and a maximum re-injection well capacity for a plurality of raw crude components;
obtaining, from an exploration and production database, a maximum rate for production of raw crude and re-injection of salt water and gas for each of a plurality of wells operatively connected to the primary-process plant facility;
determining a maximum crude production rate based on the maximum processing capacity, the maximum discharge pump capacity, the maximum re-injection well capacity, and the maximum rate of production of raw crude and re-injection of salt water and gas; and
determining if the maximum crude production rate equals or exceeds the required crude production rate.

2. The method of claim 1, further comprising determining at least one action to remedy a failure to meet the required crude production rate.

3. The method of claim 1, wherein determining if the maximum crude production rate equals or exceeds the required crude production rate or determining at least one action to remedy any failure comprises applying an artificial intelligence method that is an expert system.

4. The method of claim 1, wherein a raw crude component comprises crude, salt water, or gas.

5. The method of claim 1, wherein the maximum rate for production of raw crude comprises a full production rate and a restricted production rate.

6. The method of claim 1, further comprising determining a Strategic Production Sequence based, at least in part, on the maximum crude production rate.

7. The method of claim 2, wherein the action to remedy a failure comprises improving the maximum processing capacity of the PPPF, installing a new PPPF, installing a new discharge pump, drilling a new production well, drilling a new re-injection well, or stimulating an existing production or re-injection wells.

8. A system, comprising:
a strategic business plan comprising a required production rate;
at least one production well;
at least one disposal well;
a processing facility connected to the at least one production well and at least one disposal well;
a database; and
a computer processor, configured to:
obtain a required crude production rate for a primary-process plant facility (PPPF) from a strategic business plan;
obtain, from a PPPF database, a maximum processing capacity, a maximum discharge pump capacity, and a maximum re-injection well capacity for a plurality of raw crude components;
obtain, from an exploration and production database, a maximum rate for production of raw crude and re-injection of salt water and gas for each of a plurality of wells operatively connected to the primary-process plant facility;
determine a maximum crude production rate based on the maximum processing capacity, the maximum discharge pump capacity, the maximum re-injection well capacity, and the maximum rate of production of raw crude and re-injection of salt water and gas; and
determine if the maximum crude production rate equals or exceeds the required crude production rate.

9. The system of claim 8, the computer processor further configured to determine at least one action to remedy a failure to meet the required crude production rate.

10. The system of claim 8, wherein determining if the maximum crude production rate equals or exceeds the required crude production rate or determining at least one action to remedy any failure comprises applying an artificial intelligence method that is an expert system.

11. The system of claim 8, wherein a raw crude component comprises crude, salt water, or gas.

12. The system of claim 8, wherein the maximum rate of production of raw crude comprises a full production rate and a restricted production rate.

13. The system of claim 8, further comprising determining a Strategic Production Sequence based, at least in part, on the maximum crude production rate.

14. The system of claim 9, wherein the action to remedy a failure comprises improving the maximum processing capacity of the PPPF, installing a new PPPF, installing a new discharge pump, drilling a new production well, drilling a new re-injection well, or stimulating an existing production or re-injection wells.

15. A non-transitory computer readable medium storing instructions executable by a computer processor, the instructions comprising functionality for:
receiving a required crude production rate for a primary-process plant facility (PPPF) from a strategic business plan;
receiving, from a PPPF database, a maximum processing capacity, a maximum discharge pump capacity, and a maximum re-injection well capacity for a plurality of raw crude components;
obtaining, from an exploration and production database, a maximum rate for production of raw crude and re-injection of salt water and gas for each of a plurality of wells operatively connected to the primary-process plant facility;
determining a maximum crude production rate based on the maximum processing capacity, the maximum discharge pump capacity, the maximum re-injection well capacity, and the maximum production rate of raw crude and re-injection of salt water and gas; and
determining if the maximum crude production rate equals or exceeds the required crude production rate.

16. The non-transitory computer readable medium of claim 15, the instructions comprising functionality for determining at least one action to remedy a failure to meet the required crude production rate.

17. The non-transitory computer readable medium of claim 15, wherein determining if the maximum crude production rate equals or exceeds the required crude production rate or determining at least one action to remedy any failure comprises applying an artificial intelligence method that is an expert system.

18. The non-transitory computer readable medium of claim 15, wherein the maximum rate of production of raw crude comprises a full production rate and a restricted production rate.

19. The non-transitory computer readable medium of claim 15, further comprising determining a Strategic Production Sequence based, at least in part, on the maximum crude production rate.

20. The non-transitory computer readable medium of claim 16, wherein the action to remedy a failure comprises improving the maximum processing capacity of the PPPF, installing a new PPPF, installing a new discharge pump, drilling a new production well, drilling a new re-injection well, or stimulating an existing production or re-injection wells.
